(19) United States
(12) Patent Application Publication
(10) Pub. No.: US 2025/0342354 A1
(43) Pub. Date: Nov. 6, 2025

(54) METHODS AND SYSTEMS FOR STREAMING CONTENT

(71) Applicant: Pluto Inc., West Hollywood, CA (US)

(72) Inventors: Jaime Arturo Valenzuela, West Hollywood, CA (US); Fernando Adrian Moreno, Lujan de Cuyo (AR)

(21) Appl. No.: 18/829,641

(22) Filed: Sep. 10, 2024

Related U.S. Application Data
(60) Provisional application No. 63/642,976, filed on May 6, 2024.

(51) Int. Cl. G06N 3/08

(52) U.S. Cl. CPC G06N 3/08

(57) ABSTRACT

An aspect of the disclosure related to methods and systems configured to identify a periodic viewing pattern for a first user and/or first user device using spectrum data obtained from time series data using a Fast Fourier Transform. A trained learning model configured to predict content requests is accessed and used to predict content requests for a first time period for the first user and/or first user device. The predicted requests are used to cause content to be provided to the first user device during the first time period.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

The present invention is related to methods and systems for streaming content over a network to viewer devices.

### Description of the Related Art

With the advent of streaming video content, viewers often consume streaming video content in a random fashion, such as on-demand. Disadvantageously, conventionally it is technically challenging to pre-identify and/or pre-fetch secondary content that is to be displayed in conjunction with the primary content.

### BRIEF DESCRIPTION OF THE DRAWINGS

FIG. 1 illustrates an example environment.

FIG. 2A is a block diagram illustrating example components of a content composer and streaming system comprising a content request prediction module.

FIG. 2B illustrates example modules and services of the content composer and streaming system.

FIGS. 3A-3E illustrate example processes.

FIGS. 4A-4Z illustrate example waveforms and related data.

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

### DETAILED DESCRIPTION

As similarly discussed above, with the advent of streaming video content, viewers often consume streaming video content in a random fashion, such as on-demand. Disadvantageously, conventionally it is technically challenging to pre-identify and/or pre-fetch secondary content (e.g., advertisements) to be displayed in conjunction with the primary content.

For example, in a given item of primary content (e.g., a movie, a television series, reality TV, a sporting event, and/or the like) and/or between items of primary content, one or more time periods may be allotted for secondary content (which may be referred to as a secondary content pod, an ad pod, or as a pod). For example, an ad pod may comprise a group of ads that are sequenced together to be played back-to-back within a single ad break/placement.

Completely filling a secondary content pod with items of secondary content, such as ads, in streaming video is technically challenging. Conventionally, secondary content requests to remote second content servers are made near (e.g., immediately before) the time the secondary content pod will be streamed to the viewer device. Because of the very short time available to make such secondary content requests, if there is no response to an initial request or the response does not include sufficient items of secondary content to fill the pod, there may not be enough time to issue a second request to another secondary content provider. This may result in an empty or only partially filled pod. The empty portion of the pod may then be dead space, providing a poor viewer experience, or may need to be filled with certain less valuable content, such as station identification or a preview of an upcoming programing.

There are several reasons why a response to a request for secondary content may not include any items of content or a sufficient number of items of content to fill a pod. By way of illustrative example, secondary content requests often return video content (e.g., ads) that need to be transcoded to a particular streaming standard (wherein a video file is converted from one format to another by adjusting parameters such as resolution, encoding, and/or bitrate). This transcoding process often takes longer than the time available to include the item of secondary content the pod prior to streaming it to the viewer device, and hence may not be available to populate the pod.

By way of further illustrative example, frequency caps are often used by certain second content providers (e.g., advertisers to prevent) to prevent the same video ad to be included multiple times in a given ad pod or subsequent ad pods. This may result in insufficient content to populate the pod. By way of yet additional example, there may simply not be sufficient items of content (e.g., advertisements) available to fill secondary content requests. Further, if a given viewer does not match certain ad targeting criteria, there may be insufficient ads available to populate a pod.

To overcome the foregoing technical challenges, methods and systems are disclosed to predict when (e.g., on what day and/or time) a given user will be viewing streaming content based on historical viewing patterns, and hence to predict ad requests associated with such streaming content.

There are various types of user viewing habits and patterns, some are random and some are non-random. There are random viewing patterns with different distributions, period viewing patterns (e.g., days of the week and times), causal and predictable viewing patterns (e.g., new episode of a series, significant news or sporting event, etc.), binge viewing patterns (e.g., where when a user starts viewing a series the user views all episodes in a single viewing session).

An example process may detect viewers that view content in a periodic or non-random, predictable manner. It is useful to determine which viewers view content in a periodic or non-random manner as the future content viewing of such viewers may be accurately predicted using methods and systems disclosed herein. This is in contrast to viewers whose viewing habits are random, and hence unpredictable. As described herein, a continuous time series of ad pod requests may be utilized to train a content viewing prediction model for user devices that exhibit periodic viewing behavior.

One or more machine learning models may be trained to predict future second content (e.g., ad) requests and impressions. Such predictions enable a determination to be made as to what secondary content (e.g., ad) inventory will be needed in the future (e.g., at specific times for specific users, such as the next 15 minutes, 30 minutes, 60 minutes, 90 minutes, etc.). Based on such predicted secondary content needs, one or more strategies may be utilized to enhance the population of pods (e.g., to ensure that pods are not empty or only partly populated with secondary content).

Such prediction may be performed utilizing a process that analyzes device session data of a given user device for video streaming. Statistical methodologies, Machine Learning systems, and/or other techniques may be utilized in analyzing the device session data to classify viewer behavior that is not random. For example, a given user may be identified using one or more items of user and/or device related identifiers. By way of illustration, Session IDs (e.g., a unique identifier that a web server assigns to a user for the duration of the current session), User IDs, and/or Device IDs (e.g., an anonymous string of alphanumeric characters that uniquely identifies a device) may be utilized to uniquely identify users and/or user devices.

Once users have been categorized, such categorization may be used to build and train machine learning models based on their viewing behavior including one or more of the following historical viewing-related data:
Viewing time(s) of day
Viewing day(s) of the week
Genres viewed
Primary content title rankings (e.g., most to least viewed overall at a given streaming service)
Actual second content (e.g., ad) impressions (e.g., views) generated.
Second content request dates and times
Number of secondary content impressions,
Title ID
Title Name,
Title Duration
Sum of Pod Durations
Number of Pods, and/or
Other historical viewing-related data

The models may be configured to learn patterns from datasets, such as by using statistical methodologies (e.g., linear regression), neural networks and/or other technologies.

Example neural networks include a Sequential Artificial Neural Network (ANN), Convolutional Neural Network (CNN), Recurrent Neural Network-Long Short Term Memory (RNN-LSTM), Bidirectional Recurrent Neural Network (RNN-BiLSTM), Convolution Recurrent Neural Network (RNN-CONV & LSTM), and/or Gated Recurrent Unit (RNN-GRU).

For example, a neural network may include one or more layers (e.g., input layer, hidden layers, output layer) of one or more nodes. The neural network may optionally include an activation function, such as a rectified linear unit (ReLU), a sigmoid function, or a tanh function, for one or more layers. A given node may input one or more items of information, such as a user's historical viewing of streaming content (e.g., e.g., day, time, genre, channel, frequency, etc.). A given node may differently weight various inputs. The weighted inputs may be summed and a function may be applied to the summed weighted inputs to generate a prediction as to a user's viewing of streaming content (e.g., e.g., viewing day(s), time(s), genre(s), channel, frequency, etc.). The prediction may be compared (e.g., using an error function) to the user's actual historical viewing patterns. If there is a difference, the difference constitutes a prediction error. The weights may be adjusted, and the prediction may be performed again to determine if the error has decreased or increased. The weights may be repeatedly adjusted until the error cannot be reduced any further or until a certain number of iterations have been performed. A gradient descent process may be utilized to reduce the error. The weights for such minimized error may then be used to again predict a user's content views, and hence in determining when pods will need to be populated.

By way of further example, a multivariate linear regression model (a statistical model which estimates the linear relationship between a scalar response and explanatory variables) may be configured to predict the number of ad impressions in an upcoming time period (e.g., the next hour) using one or more of the following independent variables:
Hour of the day,
Weekday,
Number of sessions (e.g., hour),
Cumulative minutes watched (e.g., hour),
Cumulative ad pod durations (e.g., hour),
Cumulative number of ad pods (e.g., hour),
Top titles (e.g., top 5, 10 or 20 titles) watched (e.g., scaled to top monthly), and/or
Previous hour number of impressions.

Thus, the models may be configured to predict future secondary placements for viewers that will consume them so that secondary content can be requested and secured sufficiently ahead of time so that pods may be more fully populated or fully populated. For example, such secondary content may be requested sufficiently ahead of time to ensure that the items of secondary content that will be used to populate a pod are transcoded and formatted in time for delivery. Further, if a first request for secondary content fails in fully populating a pod, there will be sufficient time to make additional requests to other secondary content provider servers so that the pod will be fully populated.

Thus, by being able to predict when non-random viewers will consume pods (e.g., ad pods), individual user information may be utilized to ensure better targeting, ensure the items of secondary video content are transcoded to a desired streaming format in time for delivery and to ensure that there is sufficient time to request secondary content from other sources if pods are not fully or sufficiently include items of secondary content. By way of example, the number of ad impressions may be predicted for certain period of time (e.g., the next 15 minutes, 30 minutes, 60 minutes, and/or other time frame) based on content being streamed, the time of day, the day of the week weekday, and/or other data. In addition, by more fully populating pods, such as ad pods, ad placement revenue may optionally be increased.

Optionally, periodic viewing behavior may be identified by detecting high amplitude harmonics in second content (e.g., ad request data) by a given user device. As will be described, periodic viewing behaves like square waves with a given duty cycle. Square waves of varying duty cycles can be synthetically created (e.g., using a learning engine, such as a neural network) to closely match actual viewing patterns.

Viewing patterns with irregular duty cycles may be sufficiently accurately modeled by providing additional data (e.g., viewing day of the week and/or time of day) to a learning engine, such as a neural network. Optionally, synthetic datasets may be generated to further generate learning models without using or in addition to using actual captured viewing data.

In order to determine which viewers the model is to be applied to, viewers having a periodic pattern of viewership are identified. By way of example, periodicity may be determined a Fast Fourier Transform algorithm. The FFT algorithm may be utilized to convert the time-domain viewership data into the frequency domain. This transformation decomposes the original signal into its constituent frequency components. Thus, the output of the FFT is a frequency spectrum, which shows the amplitude of frequency components present in the original signal. The x-axis of the spectrum may represent frequency and the y-axis may represent amplitude. Peaks in the frequency spectrum correspond to dominant frequencies in the original time data. The height of each peak indicates the strength or amplitude of the corresponding frequency component. By examining the peaks in the frequency spectrum, periodic components present in the time data may be identified. The frequency of a given peak corresponds to the reciprocal of the period of the corresponding waveform in the time domain. By way of further example, ANOVA (Analysis of Variance) may be utilized to identify viewers having a periodic pattern of viewership.

For example, time series data from a given user device, having data for corresponding intervals (e.g., each hour) exhibiting periodic patterns may be used to train a model such as a neural network. By way of example, such time series periodic viewership data may be utilized to train a neural network such as a GRU Neural Network topology (e.g., with 4 hidden layers with 100 neurons per layer).

Because the FFT converts a signal from its original time domain to a representation in the frequency domain, the time series may be analyzed in the frequency domain to determine whether its harmonics indicate if the time series is periodic and a sufficiently good candidate to train the model. Optionally, the dataset may be divided into a training set and a test set for evaluation of the model. Optionally, having identified the ad request data that exhibits periodic patterns, a multivariate linear regression model may be configured and used to predict future ad requests.

Optionally, once periodic patterns are detected (e.g., using the FFT or ANOVA techniques) a low pass filter may be applied on the data to reduce or eliminate noise components in the requests and obtain more accurate predictions. For example, such filtering may be performed using an IIR (Infinite Impulse Response) or FIR (Finite Impulse Response) filter. Such filtering has been demonstrated to significantly improve the prediction accuracy of viewing patterns, and hence the predictions of ad request values. Optionally, the low-pass filter may be configured with a cut off frequency targeting the highest harmonic thereby greatly improving the accuracy of the predicted ad request values.

By way of example, optionally the low-pass filter is of 65 order with cutoff frequency of 264 hz (44*6 where 44 is the higher harmonic detected by the periodicity algorithm). If the loss is acceptable after training the model with the filtered ad break time series (e.g., lower than 0.05), the model is deemed to be reliable.

Thus, as described herein, periodic viewing behavior can be identified by detecting high amplitude harmonics in ad request data (which corresponds to when a user device is receiving streaming content). Periodic viewing behaves like square waves with a given duty cycle. Square waves of varying duty cycles may be synthetically created to closely match actual viewing patterns. Viewing patterns with irregular duty cycles may be modeled with sufficient accuracy by optionally providing additional data to a learning engine (e.g., a neural network), as day of the week and/or time of day. Synthetic datasets may optionally be generated to further generate models outside of actual captured data.

Certain training may be performed on the client device (on the user device-side, where the user device may host a content streaming application) or on the content service side (e.g., on the server side).

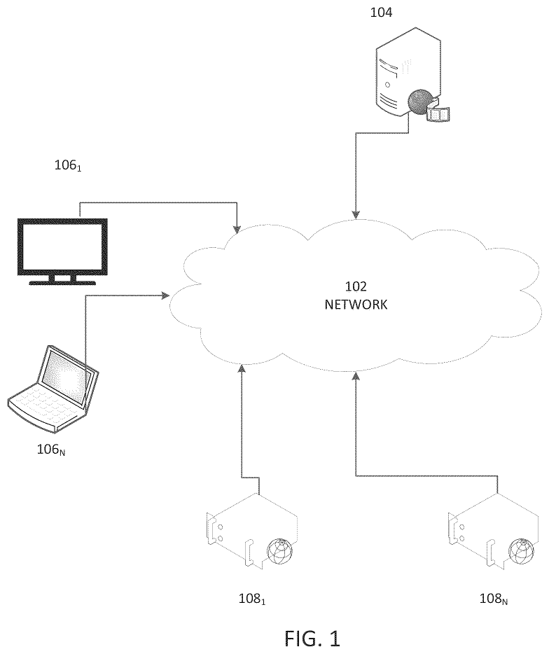

Certain example aspects will now be discussed with reference to the figures. FIG. 1 illustrates an example environment. A content composer and streaming system 104 (which may include a stitcher component, such as a server, providing stitcher services or where a stitcher system may include a content composer component, or where the content composer and the stitcher may be independent systems) is connected to a network 102 (e.g., the Internet, an intranet, or other network). The content composer and streaming system 104 is configured to communicate with client devices 1061 . . . 106n (e.g., connected televisions, smart phones, laptops, desktops, game consoles, streaming devices that connect to televisions or computers, etc.) that comprise video players. By way of example, the video player may be embedded in a webpage, may be a dedicated video player application, may be part of a larger app (e.g., a game application, a word processing application, etc.), may be hosted by a connected television (CTV), or the like. For example, as described elsewhere herein, the content composer and streaming system 104 may receive a request for media from a given client device 106 in the form of a request for a playlist manifest or updates to a playlist manifest. The content composer and streaming system 104 may identify, from a file, the location and length of an interstitial pod (a time frame reserved for interstitials, wherein one or more interstitials may be needed to fill a pod), determine context information (e.g., information regarding the primary content being requested, information regarding the user, and/or other context information), solicit and select interstitial content from third parties, define customized interstitials as described herein, generate playlist manifests, and/or perform other functions described herein.

The content composer and streaming system 104 and/or another system may stream requested content to the requesting device 106. The content composer and streaming system 104 may stream content or cause to be streamed to a client device 106 in response to a request from the client device made using a playlist manifest entry (e.g., an ad pod entry) or the content composer and streaming system 104 may stream or caused to be streamed content to a client device 106 in a push manner (in the absence of a client device request).

Optionally, the content composer and streaming system 104 may transmit context information to one or more interstitial source systems 1081 . . . 108n. For example, the source systems 1081 . . . 108n may optionally include ad servers, and the interstitial content may comprise ads. The interstitial source systems 1081 . . . 108, may comply with the VAST protocol. By way of further example, the interstitial source systems 1081 . . . 108, may provide ads, public service videos, previews of upcoming programs, quizzes, news, games, and/or other content. The interstitial source systems 1081 . . . 108n may use the context information in determining what interstitial content is to be provided or offered to the requesting client device 106. Thus, for example, the interstitial source systems 1081 . . . 108n may provide content in response to content request predictions, such as discussed herein.

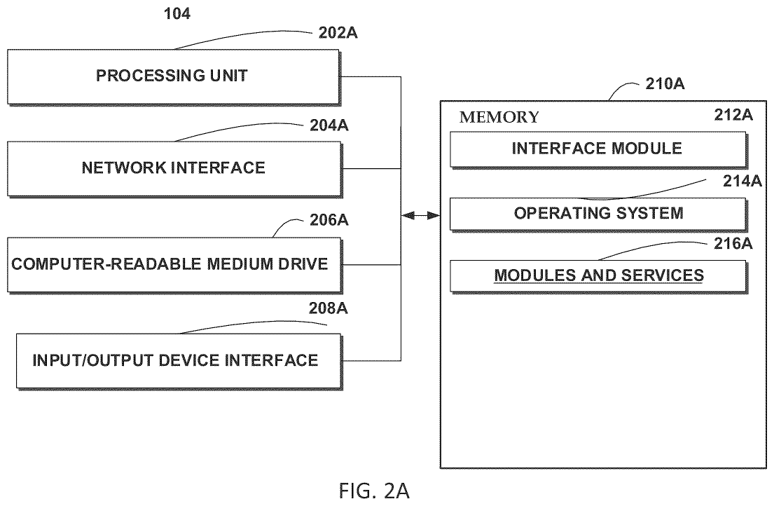

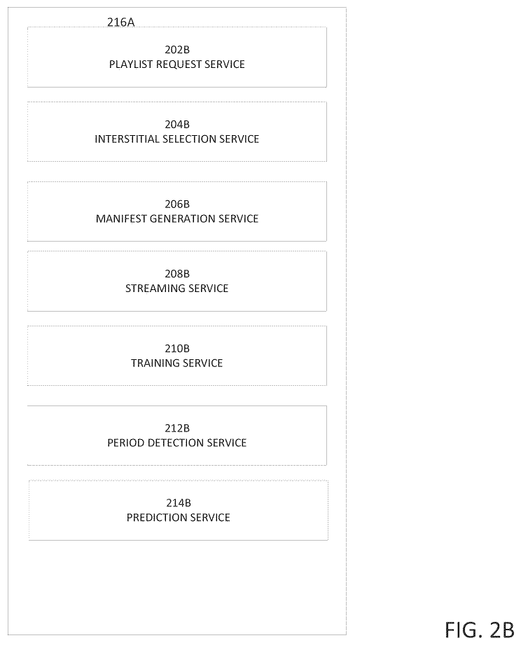

FIG. 2A is a block diagram illustrating example components of a content composer and streaming system 104. The example content composer and streaming system 104 includes an arrangement of computer hardware and software components that may be used to implement aspects of the present disclosure. Those skilled in the art will appreciate that the example components may include more (or fewer) components than those depicted in FIG. 2A.

The content composer and streaming system 104 may include one or more processing units 202A (e.g., a general purpose processor, an encryption processor, a video transcoder, and/or a high speed graphics processor), one or more network interfaces 204A, a non-transitory computer-readable medium drive 206A, and an input/output device interface 208A, all of which may communicate with one another by way of one or more communication buses. The network interface 204A may provide the various services described herein with connectivity to one or more networks (e.g., the Internet, local area networks, wide area networks, personal area networks, etc.) and/or computing systems (e.g., interstitial source systems, client devices, etc.). The processing unit 202A may thus receive information, content, and instructions from other computing devices, systems, or services via a network, and may provide information, content (e.g., streaming video content), and instructions to other computing devices, systems, or services via a network. The processing unit 202A may also communicate to and from non-transitory computer-readable medium drive 206A and memory 210A and further provide output information via the input/output device interface 208A. The input/output device interface 208A may also accept input from various input devices, such as a keyboard, mouse, digital pen, touch screen, microphone, camera, etc.

The memory 210A may contain computer program instructions that the processing unit 202A may execute in order to implement one or more embodiments of the present disclosure. The memory 210A generally includes RAM, ROM and/or other persistent or non-transitory computer-readable storage media. The memory 210A may store an operating system 214A that provides computer program instructions for use by the processing unit 202A in the general administration and operation of the modules and services 216A, including its components. The modules and services 216A are further discussed with respect to FIG. 2B and elsewhere herein. The memory 210A may further include other information for implementing aspects of the present disclosure.

In an example embodiment, the memory 210A includes an interface module 212A. The interface module 212A can be configured to facilitate generating one or more interfaces through which a compatible computing device may send to, or receive from, the modules and services 216A.

The modules or components described above may also include additional modules or may be implemented by computing devices that may not be depicted in FIGS. 2A and 2B. For example, although the interface module 212A and the modules and services 216A are identified in FIG. 2B as single modules, the modules may be implemented by two or more modules and in a distributed manner. By way of further example, the processing unit 202A may optionally include a general purpose processor and may optionally include a video codec. The system 104 may offload certain compute-intensive portions of the modules and services 216A (e.g., Fast Fourier Transform operations, transcoding and/or transrating a stream for adaptive bitrate operations, compositing, and/or the like) to one or more dedicated devices, such as a video codec (e.g., H.264 encoders and decoders) or signal processors with FFT-specific architectures, while other code may run on a general purpose processor. The system 104 may optionally be configured to support multiple streaming protocols, may provide low latency pass-through, and may support a large number of parallel streams (e.g., HD, 4K, and/or 8K streams). The processing unit 202A may include hundreds or thousands of core processors configured to process tasks in parallel. A GPU may include high speed memory dedicated for graphics processing tasks. As another example, the system 104 and its components can be implemented by network servers, application servers, database servers, combinations of the same, or the like, configured to facilitate data transmission to and from data stores, user terminals, and third party systems via one or more networks. Accordingly, the depictions of the modules are illustrative in nature.

The modules and services 216A may include modules that provide a playlist request service, an interstitial selection service 204B (which may also select sections to create a customized interstitial), and a playlist manifest generation service 208B.

The playlist request service 202B may receive and process requests for playlist manifests. The interstitial selection service 204B may assemble content information for a given interstitial pod (e.g., the length of the interstitial pod, the subject matter of requested primary content, information regarding a channel the viewer is watching, the content of a scene in which the interstitial pod is located, etc.) and transmit the information to one or more interstitial source systems. For example, the interstitial selection service 204B may assemble content information for a given interstitial pod predicted to occur at a given time using the learning engine described herein. The interstitial source systems may propose interstitial content to the interstitial selection service 204B of the stitching system. The interstitial selection service 204B may evaluate the proposals and select one or more items of interstitial content for inclusion in the interstitial pod.

The manifest generation service 206B may be used to assemble a playlist manifest (e.g., an HLS or MPEG DASH manifest) including locators (e.g., URLs) pointing to segments and sections of primary and interstitial content and locators (e.g., URLs), organized to correspond to the desired playback sequence. The manifest may be transmitted to a client on a user device. The client may then request a given item of content (e.g., section or segment) as needed, which may then be served (e.g., streamed) by the corresponding content source or intermediary to the client.

The content streaming service 208B may stream content (e.g., video content) to content reproduction user devices 106 and/or other destinations.

The training service 210B may be configured to train learning engines (e.g., neural network-based learning engines) as described elsewhere herein. The period detection service 212B may be configured to detect periodic viewing histories as described elsewhere herein.

The prediction service 214B may be configured to predict upcoming content viewing and/or upcoming ad breaks as described elsewhere herein.

Optionally, the prediction and/or training service may reside on a client device. Optionally, each user/client may have a prediction model customized for that user/client.

Certain example processes will now be described. The processes may refer to the following services and functions:
ML Train Job: a process running from time to time to train the NN Model (or other model).
ML Predict Job: a process running from time to time to predict Adpod requests for the next time period in the series.
Adpod Request Counter: a process running inside the client app that stores the Stitcher requests triggered by the client. Client devices may not be aware when the Adpod service is called. However, linear streams (stream Type=channel) contain Stitcher requests that are equivalent. The client app then counts and stores Stitcher requests triggered per hour and stores them locally. This data is the time series to be used by ML Train Job and ML Predict Job
NN Model service: microservices that the ML Job may call to obtain the neural network (NN) model to train.
Predicted Ads Manager: microservices that the client app (e.g., ROKU, IOS, etc.) will send the predicted results.

The ML Train Job obtains a series of ad breaks triggered by the client and a list of the more popular titles (e.g., the top 5, 10, 15, or 20 series/titles). If the user is viewing one of the more popular titles and passes a periodicity test (where the user's viewing habits is sufficiently periodic), it may be designated as a good candidate to train the learning model (e.g., a neural network-based model). If the loss/error in training is low enough (e.g., less than a specified threshold), the trained model is saved and may be used to perform predictions of ad breaks/ad requests.

Depending on the client device capabilities, training the model and obtaining inferences may execute within the application on the client device. If the client device does not have enough power or capabilities, the training and inference process may run on a server or other computer system remote from the client device.

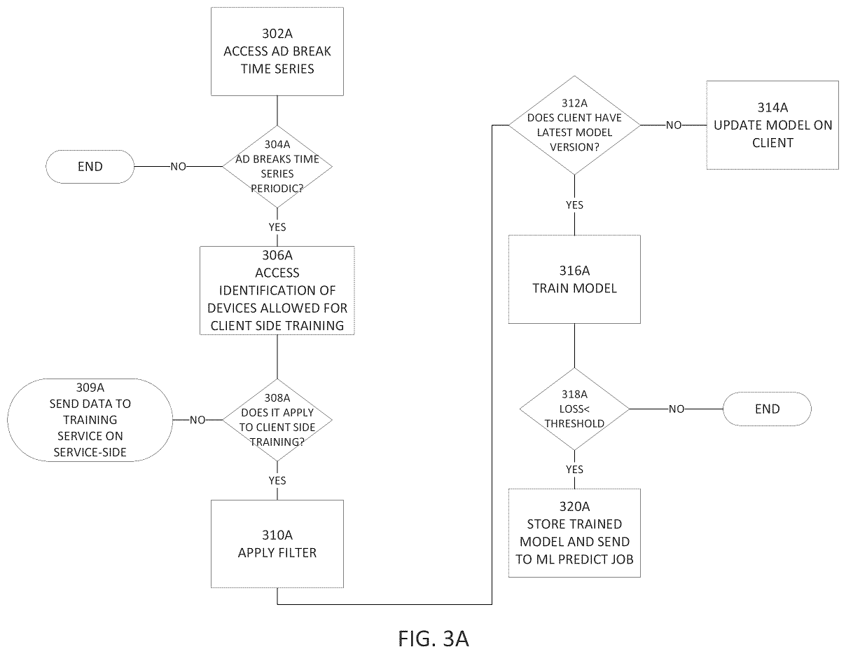

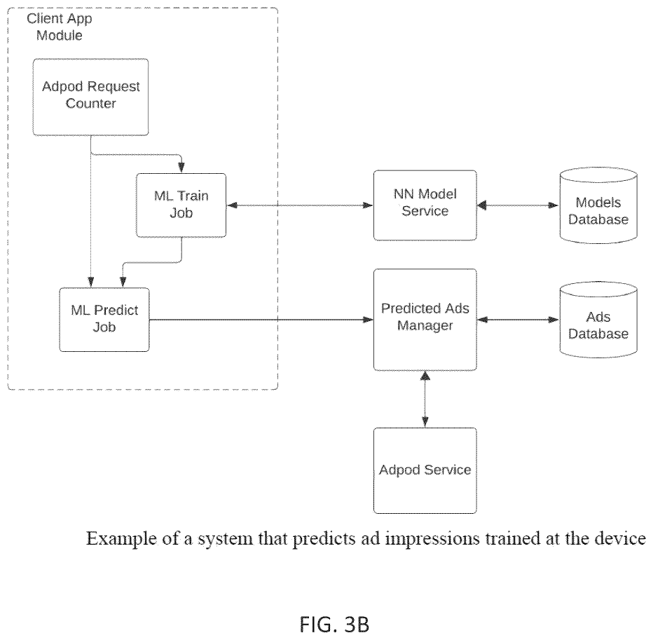

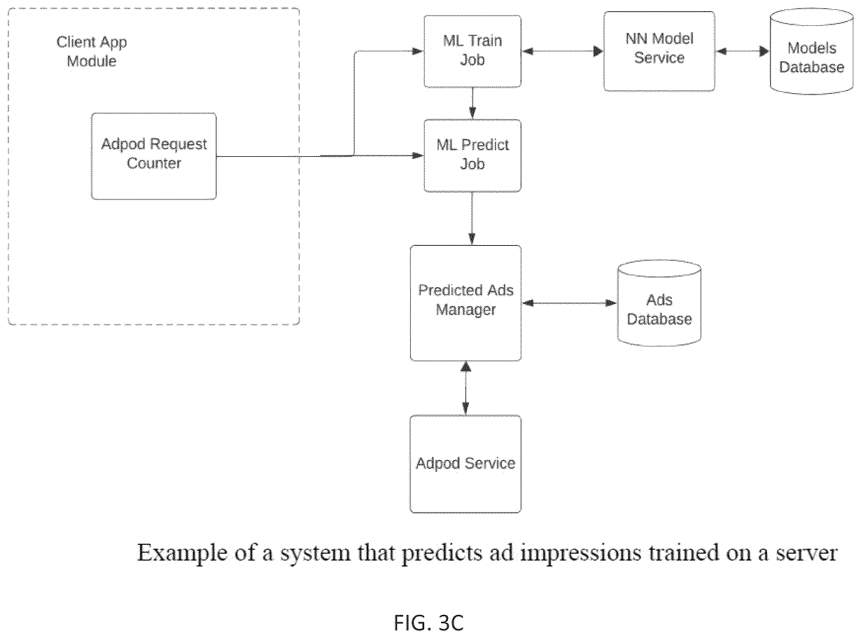

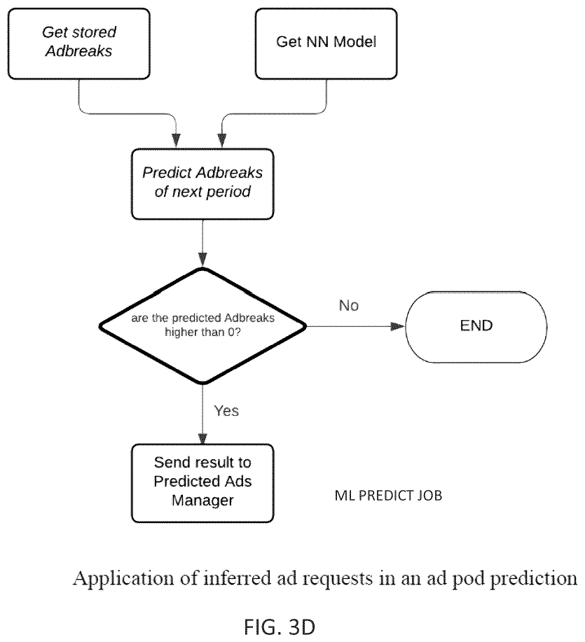

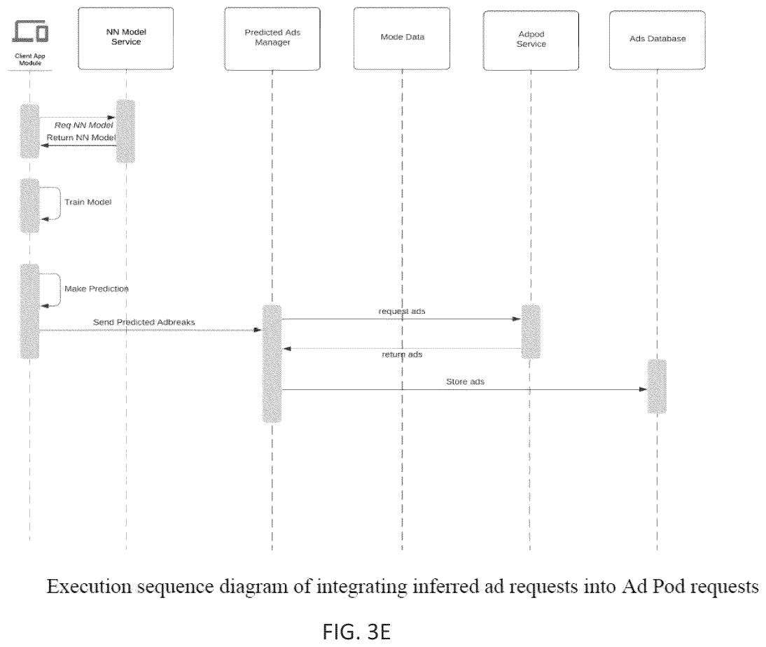

FIG. 3A illustrates an example process for client-side training. At block 302A, an ad break (e.g., an ad pod) time series is accessed to determine whether it has adequate properties for being used to train a viewership prediction model (e.g., a model configured to predict viewing patterns and/or ad requests). At block 304A, a determination may be made as to whether the ad breaks are sufficiently periodic (e.g., as determined using techniques described herein). If the ad breaks are not sufficiently periodic, the process may end.

If the ad breaks are sufficiently periodic, at block 306A, a list of client devices available for client side training may be accessed from memory. At block 308A, a determination may be made whether it applies to client-side training. If a determination is made that it does not apply to client-side training, at block 309A, the data may be sent to a server-side training service. If a determination is made that it does apply to client-side training, at block 310A, a filter (e.g., a low-pass filter) may be applied to the data (e.g., to eliminate or reduce noise components).

At block 312A, a determination may be made as to whether the client has the latest version of the model (e.g., the neural network model as disclosed elsewhere herein).

If the client does not have the latest version of the model, at block 314A, the model may be updated to the latest model. If the client has the latest version of the model, at block 316A, the model may be trained using the filtered data. At block 318A, a determination is made as to whether the loss is sufficiently low (e.g., lower than a specified threshold). If a determination is made that the loss is not sufficiently low (e.g., less than a specified threshold), the process may end. If a determination is made that the loss is sufficiently low, at block 320A, the trained model may be stored in memory and may be utilized to perform machine learning prediction. For example, the model may be utilized to make a prediction of ad pod requests for an upcoming period (e.g., the next 60 minutes) and returns an inferred value. A process may be run periodically, at a specified, or at scheduled times train the prediction model. The model may be transmitted to the ML predict job illustrated in FIG. 3D.

FIG. 3B illustrates an example of a system and process that predicts ad requests/impressions, trained at the client device. The Adpod Request Counter counts and stores the stitcher requests (e.g., ad requests) triggered by the client over a period of time (e.g., per hour) and optionally stores the request count locally. This data comprises the time series used by the ML Train Job and ML Predict Job services.

The ML Train Job services uses the time series data and optionally a list of the more popular titles (e.g., the top 5, 10, 15, or 20 series/titles). If the user is viewing one of the more popular titles and passes a periodicity test (where the user's viewing habits is sufficiently periodic), it may be designated as a good candidate to train the learning model (e.g., a neural network-based model). The ML Job service may call the NN Model service to obtain the neural network (NN) model to train. If the loss/error in training is low enough (e.g., less than a specified threshold), the trained model is saved in a models database and may be used to perform predictions of ad breaks/ad requests.

The ML Predict Job service predicts Adpod/ad requests for the next time period in the time series and may pass requests to the Adpod service.

FIG. 3C illustrates an example of a system and process that predicts ad requests/impressions, trained at the server. The server receives the output of the Adpod request counter (the number stitcher requests (e.g., ad requests)). This data comprises the time series used by the ML Train Job and ML Predict Job services.

The ML Train Job services uses the time series data and optionally a list of the more popular titles (e.g., the top 5, 10, 15, or 20 series/titles). If the user is viewing one of the more popular titles and passes a periodicity test (where the user's viewing habits is sufficiently periodic), it may be designated as a good candidate to train the learning model (e.g., a neural network-based model). The ML Job service may call the NN Model service to obtain the neural network (NN) model to train. If the loss/error in training is low enough (e.g., less than a specified threshold), the trained model is saved in a models database and may be used to perform predictions of ad breaks/ad requests. The ML Predict Job service predicts Adpod/ad requests for the next time period in the time series and may pass requests to the Adpod service.

FIG. 3D illustrates an example ad pod (ad request) prediction process. The ad breaks and the trained model (e.g., neural network-based model) are accessed. The ad breaks for a next time period (e.g., the next 30 minutes, 60 minutes, 120 minutes, etc.) are predicted. A determination is made as to whether the number of predicted ad breaks is greater than zero. If the number of predicted ad breaks is not greater than zero, the process may end. If the predicted ad breaks is greater than zero, the predicted results are sent to an ad manager, which may in turn request ads sufficiently ahead of the predicted ad break (e.g., the predicted ad pod/ad requests).

FIG. 3E illustrates an example sequence diagram illustrating the integration of inferred/predicted ad requests into ad pod requests. A client application may request a neural network model from a model service, which may return the requested model. The client application may train the model and use the model to predict ad requests (ad breaks). The ad request prediction may be transmitted by the client to a predicted ads manager. The predicted ads manager may request ads from an ad pod service. The ad pod service may return ads to the predicted ads manager. The predicted ads manager may store the returned ads in an ads database.

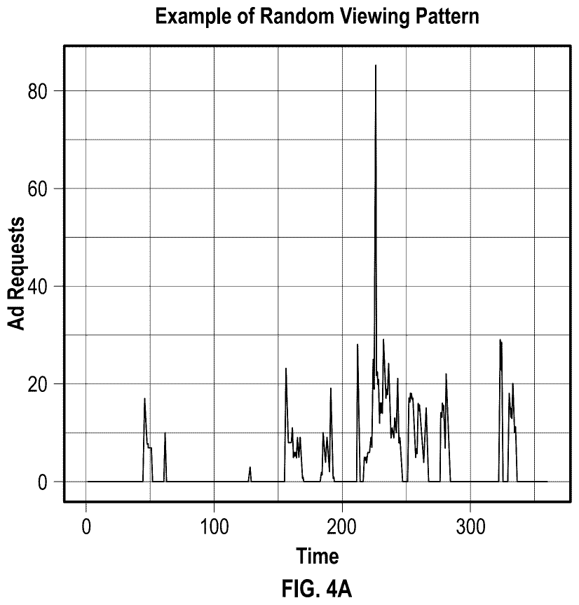

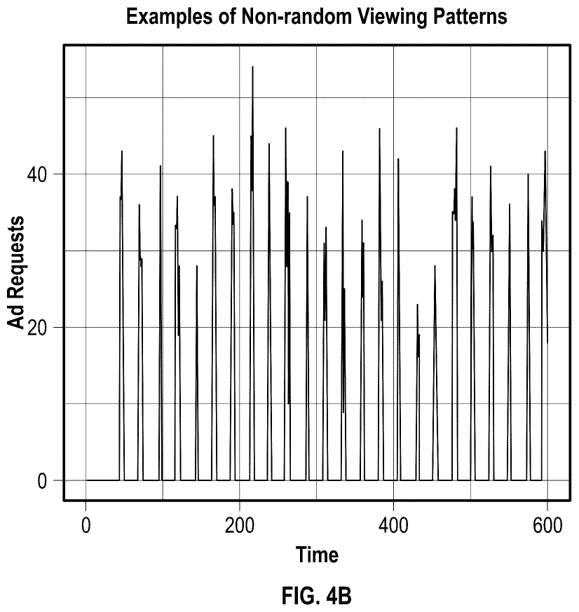

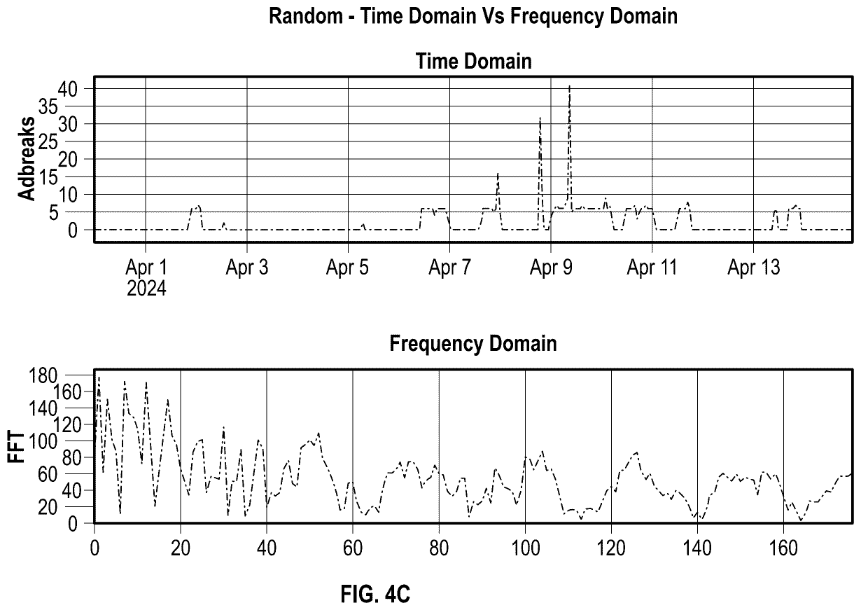

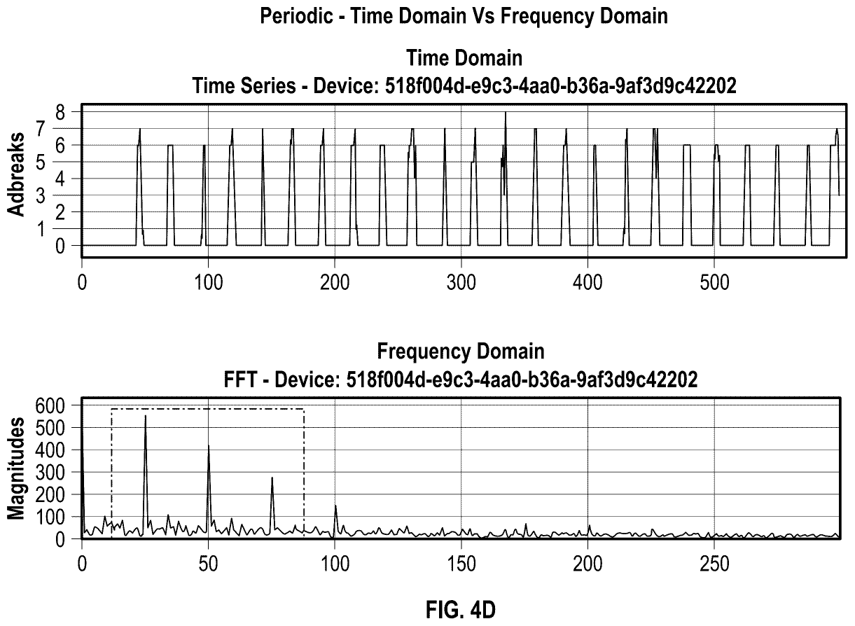

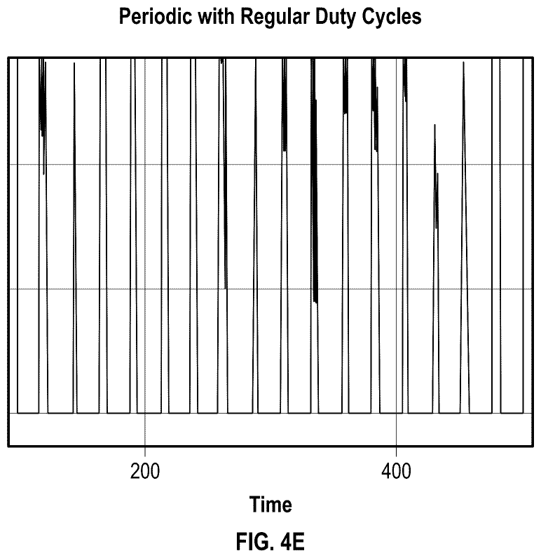

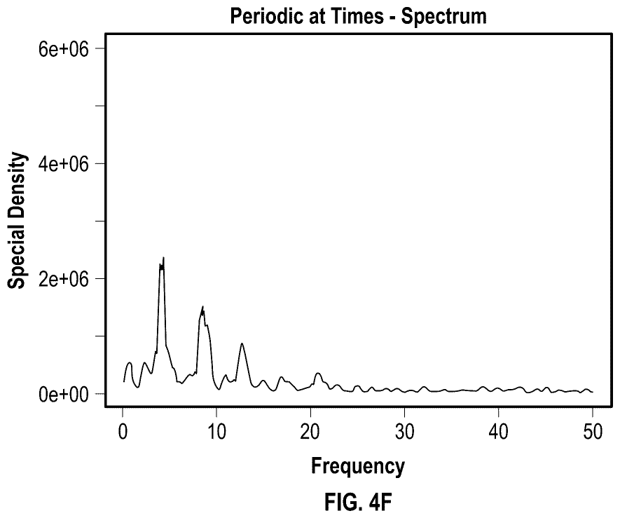

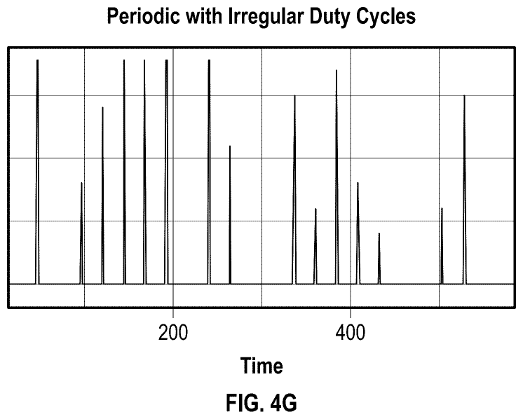

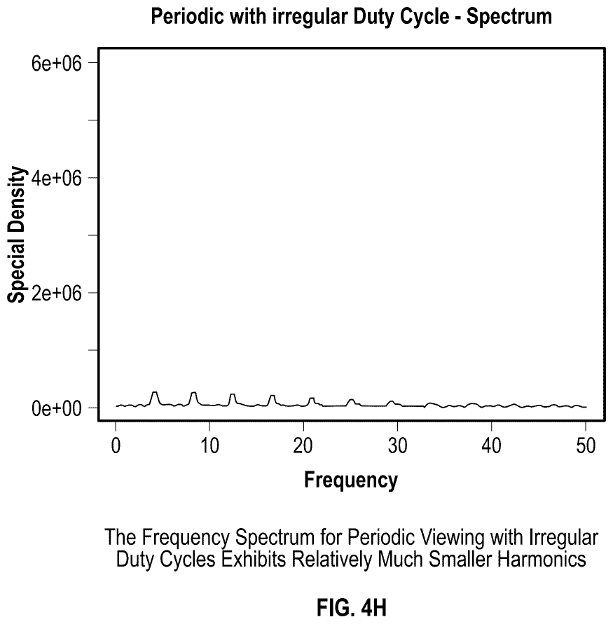

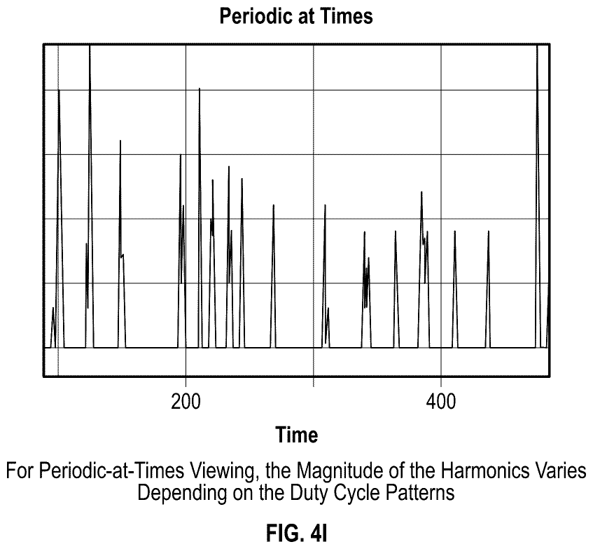

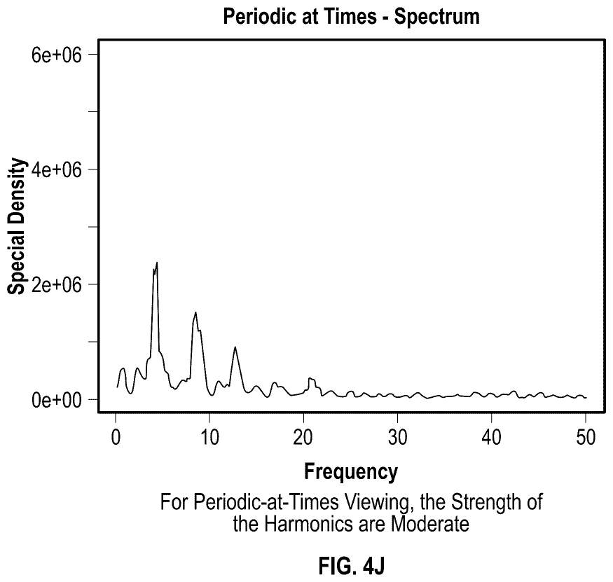

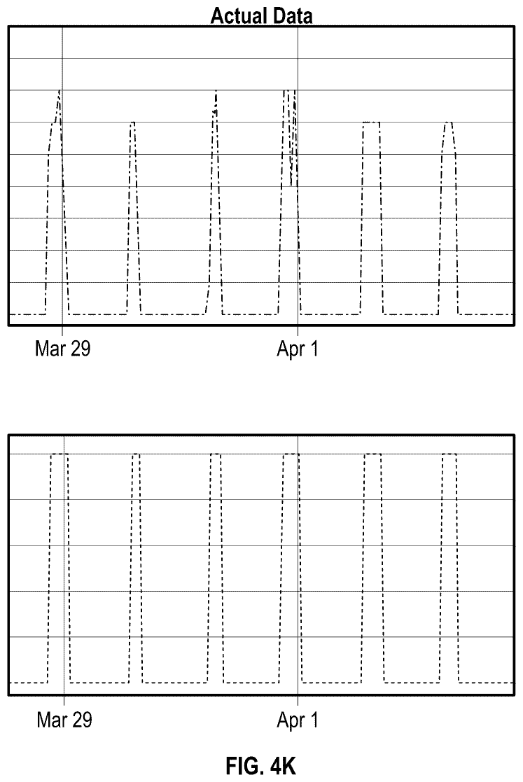

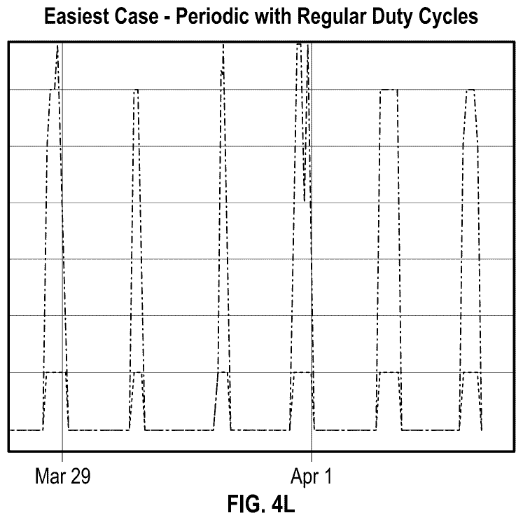

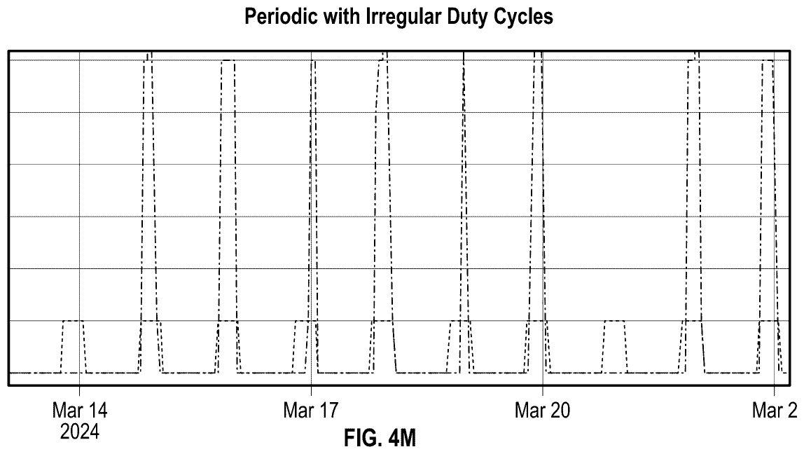

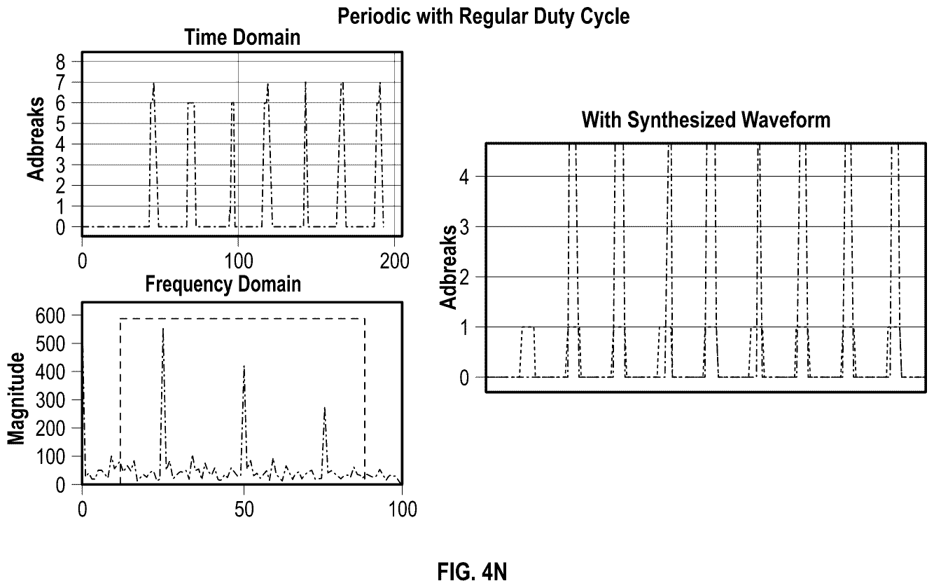

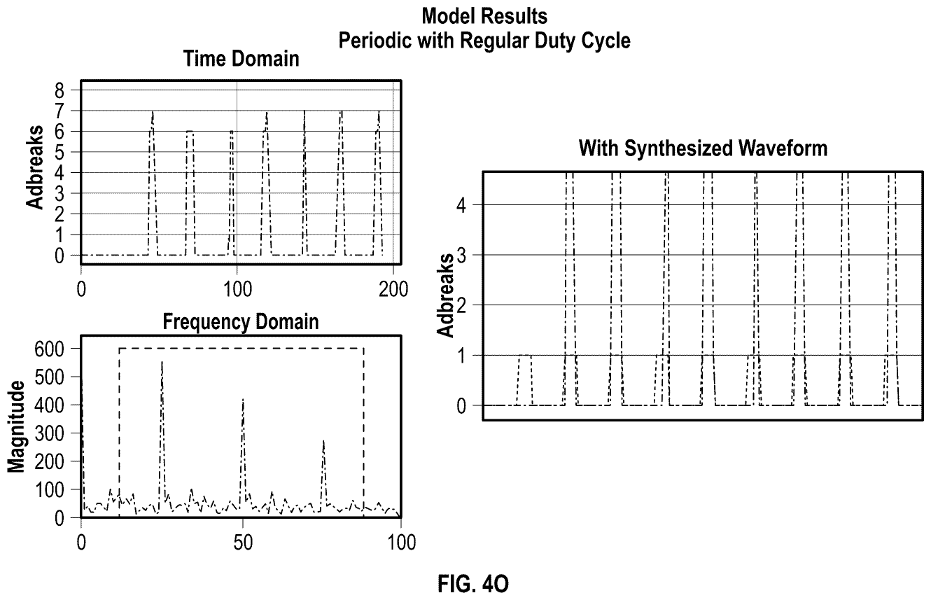

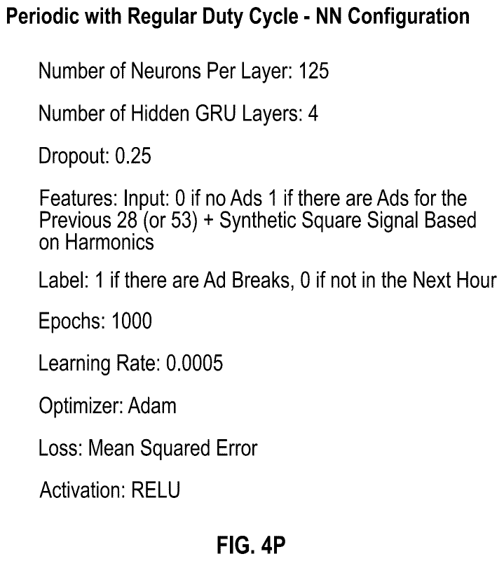

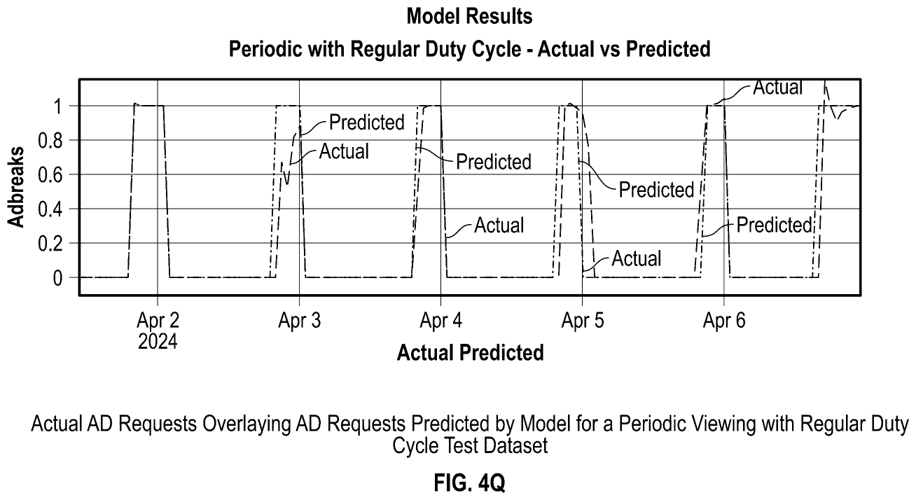

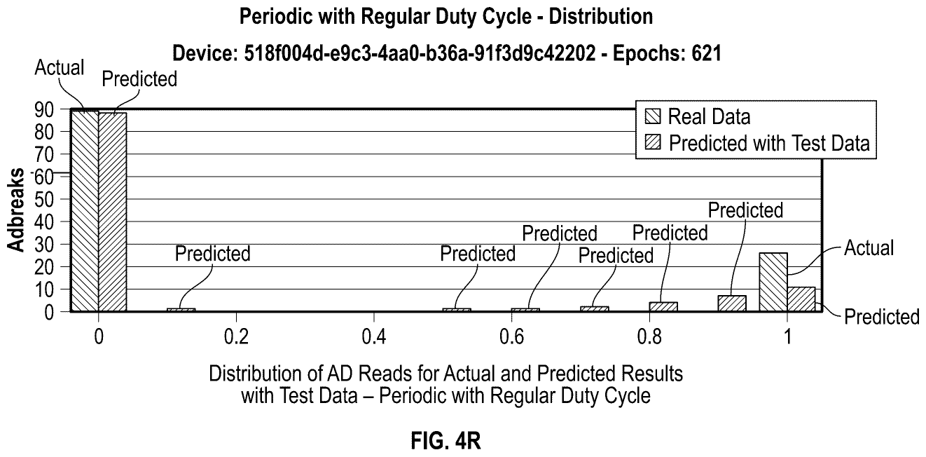

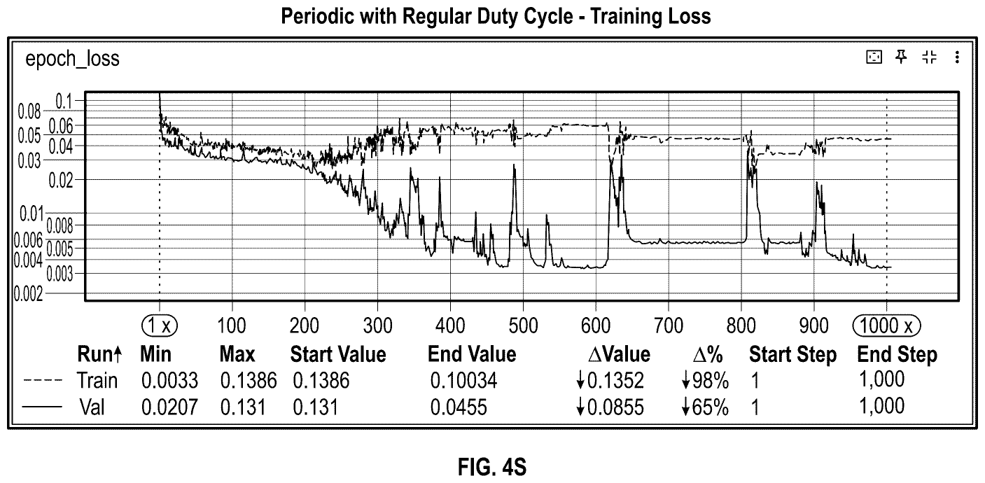

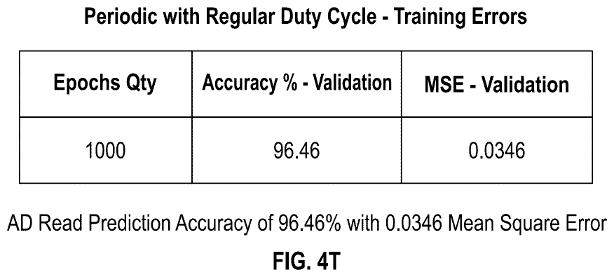

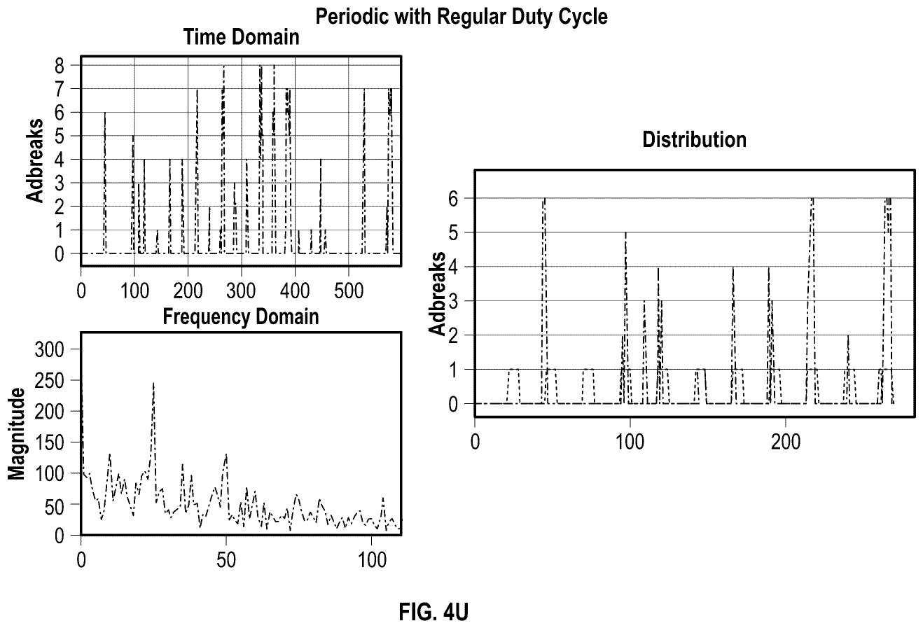

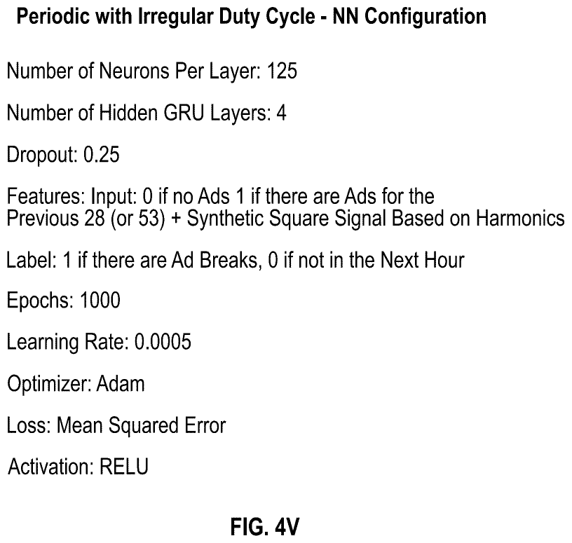

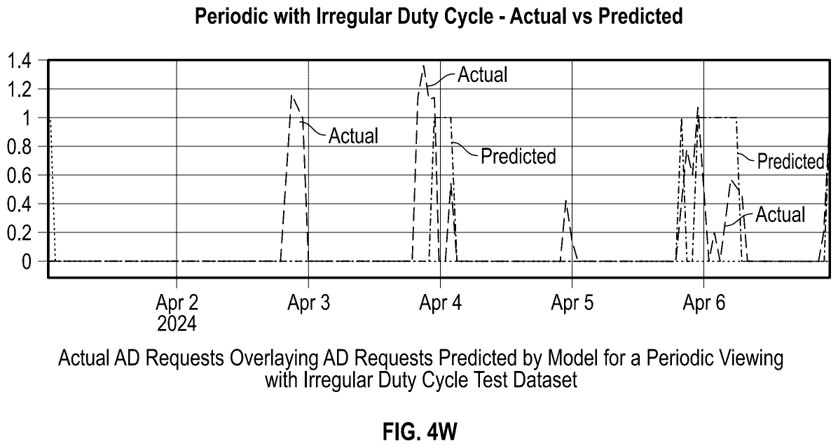

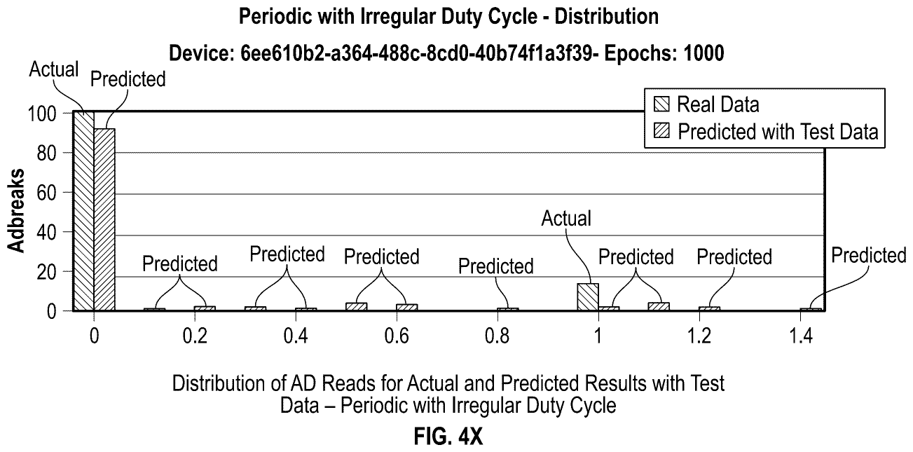

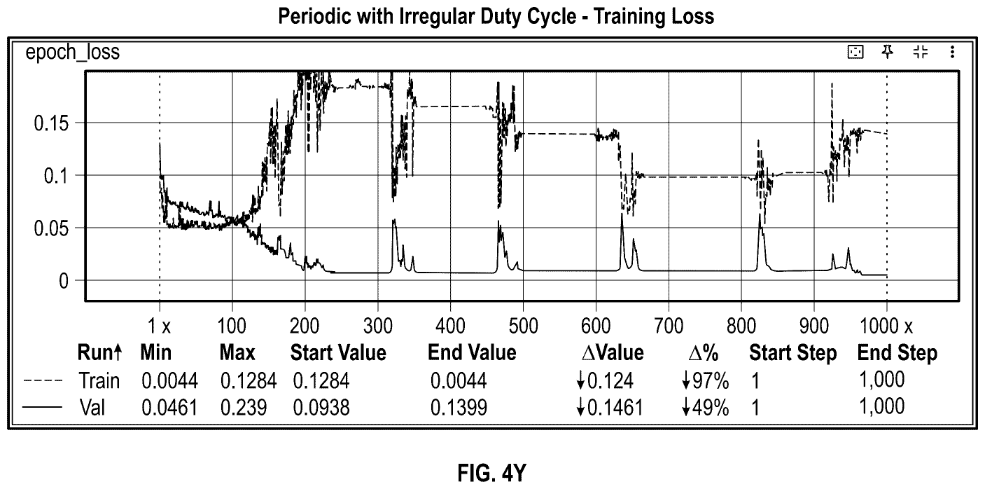

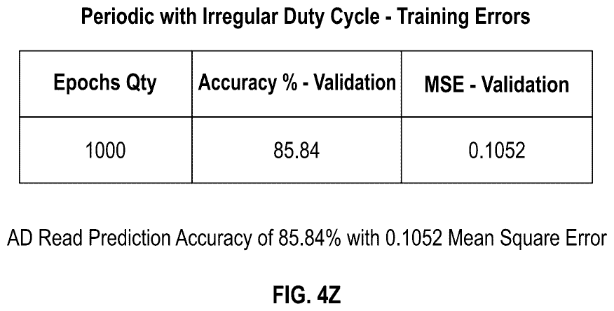

FIGS. 4A-4Z illustrate example waveforms and related data.

FIG. 4A illustrates an example waveform of random viewing patterns, with the y-axis being the number of ad requests and the x-axis being time. The waveform illustrates inconsistent weekday, time of day, and duration of viewing. By contrast, FIG. 4B illustrates an example waveform of non-random, periodic viewing patterns, with consistent weekday, time of day, and duration of viewing.

FIG. 4C illustrates random viewing patterns in the time domain and the frequency domain.

FIG. 4D illustrates periodic viewing patterns in the time domain and the frequency domain. The frequency domain exhibits distinct spikes at certain frequencies indicating the presence of a periodic viewing pattern.

FIG. 4E illustrates a regular duty cycle corresponding to periodic viewing. The duty cycle corresponds to the percentage of time that a viewer is active, viewing streamed content.

FIG. 4F illustrates a spectrum/frequency plot of periodic-at-times viewing. Strong/high harmonics are present when the user engages in regular viewing.

FIG. 4G illustrates a periodic, irregular duty cycle, wherein a user does not view content each day (and hence ad requests are not received from the user device each day) but when the user is viewing content, it is during a consistent time period (e.g., 7-10 PM). FIG. 4H illustrates a spectrum of the periodic, irregular duty cycle of FIG. 4G. As can be seen, the harmonics are much smaller than in the case of the periodic, regular duty cycle of FIG. 4D.

FIG. 4I illustrates the duty cycle for periodic at times viewing. For periodic-at-times viewing, the magnitude of the harmonics will vary depending on the duty cycle patterns. FIG. 4J illustrates a spectrum of the periodic at times duty cycle of FIG. 4I. As can be seen, the harmonics are smaller than in the case of the periodic, regular duty cycle of FIG. 4D and larger than in the case of the periodic, irregular duty cycle of FIG. 4H.

With reference to FIG. 4K, the frequency spectrum of the time series may be utilized to generate a synthetic square wave using the previously detected main harmonic frequencies by applying an inverse Fourier transform, where a square wave is a combination of many frequencies. The synthesized waveform may be utilized to train a learning model (e.g., a neural network), as similarly described elsewhere herein. Advantageously, the use of synthetic data provides greater flexibility to determine if a given learning model is sufficiently accurate in predicting content viewing/requests (e.g., ad requests), and if additional data points improve prediction accuracy.

With reference to FIG. 4L, in the case of periodic viewing with regular duty cycles, real data harmonics may be utilized to synthesize a square having a matching duty cycle. The synthetic data may be utilized to train the learning model (e.g., a neural network, such as described elsewhere herein) to provide accurate predictions with minor variations.

With reference to FIG. 4M, in the case of periodic viewing with irregular duty cycles, a square wave may be synthesized with a regular duty cycle and tested against data for users with viewing patterns with irregular duty cycles. It was determined that the model's prediction performance may be significantly improved by providing additional data (e.g., time of day, day of week, and/or other data) in the model data training set.

With reference to FIG. 4N, in the case of periodic viewing with regular duty cycles, waveforms are illustrated in the time domain, the frequency domain, and with a synthesized waveform. Prior to training the learning model (e.g., a neural network), the training data may be processed. As similarly discussed elsewhere herein, periodicity in a user's viewing behavior may be detected by transforming content request (e.g., ad request) time series data to the frequency domain using Fast Fourier Transforms. The frequency domain data may then be analyzed to detect whether there are strong harmonics (indicating periodic viewing with a regular duty cycle). In response to detecting such strong harmonics (e.g., one or more harmonics greater than a corresponding threshold) a square wave may be synthesized to closely match the original time series data by extracting the higher harmonics and applying inverse Fourier transform to obtain time series data.

FIG. 4O illustrates example model results generated using the synthesized square wave generated from the extracted main harmonics.

FIG. 4P provides the example neural network learning engine configuration for the model configured to provide predictions for periodic viewing with regular duty cycle. In this example, 1000 epochs (training cycles) is used to ensure model convergence.

FIG. 4Q illustrates example model results for periodic viewing with regular duty cycle, with a comparison of the actual content (e.g., ad) requests and the model predictions for the test dataset. As can be seen, the model request predictions are very close to the actual requests.

FIG. 4R illustrates, for periodic with regular duty cycle, an example distribution of actual content requests/ad reads and for predicted content requests/ad reads with test data.

FIG. 4S illustrates, for periodic with regular duty cycle, example training losses/errors for respective epochs, showing where they converge. FIG. 4T illustrates, for periodic with regular duty cycle, the accuracy results. In this example, an ad read prediction accuracy of 96.46% was achieved with a 0.0346 mean square error.

FIG. 4U illustrates the output results for a learning model for a dataset with periodic viewing having irregular duty cycles, using the main harmonics (having relatively low amplitude).

FIG. 4V provides the example neural network learning engine configuration for the model configured to provide predictions for periodic viewing with irregular duty cycle.

In this example, 1000 epochs (training cycles) is used to ensure model convergence.

FIG. 4W illustrates example model results for periodic viewing with irregular duty cycle, with a comparison of the actual content (e.g., ad) requests and the model predictions for the test dataset. FIG. 4X illustrates, for periodic with irregular duty cycle, an example distribution of actual content requests/ad reads and for predicted content requests/ad reads with test data.

FIG. 4Y illustrates, for periodic with irregular duty cycle, example training losses/errors for respective epochs, showing where they converge.

FIG. 4Z illustrates, for periodic with irregular duty cycle, the accuracy results. In this example, an ad read prediction accuracy of 85.84% was achieved with a 0.1052 mean square error.

Thus, as described herein, systems and methods are disclosed that overcome the technical problems related to timely providing content, such as ad or other interstitial content, by predicting upcoming viewing and/or ad breaks/demands.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a dropdown menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc. While the above detailed description has shown, described, and pointed out novel features as applied to various embodiments, it can be understood that various omissions, substitutions, and changes in the form and details of the systems, devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for predicting content requests, the system comprising:
a computer device;
a network interface;
non-transitory computer readable memory having program instructions stored thereon that when executed by the computer device cause the system to perform operations comprising:
identify a periodic viewing pattern for a first user and/or first user device;
access a trained learning model configured to predict content requests;
use the trained learning model to predict content requests for a first time period for the first user and/or first user device;
use the predicted content requests to cause content to be provided to the first user device during the first time period.

2. The system as defined in claim 1, wherein the training learning model comprises a neural network comprising an input layer, one or more hidden layers, an output layer, and an activation function.

3. The system as defined in claim 1, wherein identifying a periodic viewing pattern for a first user and/or first user device further comprises:
receiving time series data corresponding to a first type of content request;
using a Fast Fourier Transform to convert the time series data to a spectrum;
analyzing harmonics in the spectrum; and
based at least on the analysis of harmonics in the spectrum, determining whether the time series data corresponds to a periodic viewing pattern.

4. The system as defined in claim 1, wherein identifying a periodic viewing pattern for a first user and/or first user device further comprises:
receiving time series data corresponding to secondary content requests;
using a Fast Fourier Transform to convert the time series data to a spectrum;
analyzing harmonics in the spectrum; and
based at least on the analysis of harmonics in the spectrum, determining whether the time series data corresponds to a periodic viewing pattern,
wherein a low pass filter is utilized to filter out noise.

5. The system as defined in claim 1, wherein the system is configured to initiate client side training of at least one model, and server side training of at least one model.

6. The system as defined in claim 1, wherein using the trained learning model to predict content requests for a first time period for the first user and/or first user device further comprises predicting secondary content requests.

7. The system as defined in claim 1, wherein the system is configured to train at least one prediction model to make content request predictions utilizing one or more synthesized square waves corresponding to actual content requests.

8. A computer implemented method, the method comprising:
identifying a periodic viewing pattern for a first user and/or first user device;
accessing a trained learning model configured to predict content requests;
using the trained learning model to predict content requests for a first time period for the first user and/or first user device;
using the predicted content requests to cause content to be provided to the first user device during the first time period.

9. The computer implemented method as defined in claim 8, wherein the training learning model comprises a neural network comprising an input layer, one or more hidden layers, an output layer, and an activation function.

10. The computer implemented method as defined in claim 8, wherein identifying a periodic viewing pattern for a first user and/or first user device further comprises:
receiving time series data corresponding to a first type of content request;
using a Fast Fourier Transform to convert the time series data to a spectrum;
analyzing harmonics in the spectrum; and
based at least on the analysis of harmonics in the spectrum, determining whether the time series data corresponds to a periodic viewing pattern.

11. The computer implemented method as defined in claim 8, wherein identifying a periodic viewing pattern for a first user and/or first user device further comprises:
receiving time series data corresponding to secondary content requests;
using a Fast Fourier Transform to convert the time series data to a spectrum;
analyzing harmonics in the spectrum; and
based at least on the analysis of harmonics in the spectrum, determining whether the time series data corresponds to a periodic viewing pattern,
wherein a low pass filter is utilized to filter out noise.

12. The computer implemented method as defined in claim 8, the method further comprising initiating client side training of at least one model.

13. The computer implemented method as defined in claim 8, wherein using the trained learning model to predict content requests for a first time period for the first user and/or first user device further comprises predicting secondary content requests.

14. The computer implemented method as defined in claim 8, the method further comprising training at least one prediction model to make content request predictions utilizing one or more synthesized square waves corresponding to actual content requests.

15. Non-transitory computer readable memory having program instructions stored thereon that when executed by a computing device cause the computing device to perform operations comprising:
identify a periodic viewing pattern for a first user and/or first user device;
access a trained learning model configured to predict content requests;
use the trained learning model to predict content requests for a first time period for the first user and/or first user device;
use the predicted content requests to cause content to be provided to the first user device during the first time period.

16. The non-transitory computer readable memory as defined in claim 15, wherein the training learning model comprises a neural network comprising an input layer, one or more hidden layers, an output layer, and an activation function.

17. The non-transitory computer readable memory as defined in claim 15, wherein identifying a periodic viewing pattern for a first user and/or first user device further comprises:
receiving time series data corresponding to a first type of content request;
using a Fast Fourier Transform to convert the time series data to a spectrum;
analyzing harmonics in the spectrum; and
based at least on the analysis of harmonics in the spectrum, determining whether the time series data corresponds to a periodic viewing pattern.

18. The non-transitory computer readable memory as defined in claim 15, wherein identifying a periodic viewing pattern for a first user and/or first user device further comprises:
receiving time series data corresponding to secondary content requests;
using a Fast Fourier Transform to convert the time series data to a spectrum;
analyzing harmonics in the spectrum; and
based at least on the analysis of harmonics in the spectrum, determining whether the time series data corresponds to a periodic viewing pattern,
wherein a low pass filter is utilized to filter out noise.

19. The non-transitory computer readable memory as defined in claim 15, the operations further comprising initiating client side training of at least one model.

20. The non-transitory computer readable memory as defined in claim 15, wherein using the trained learning model to predict content requests for a first time period for the first user and/or first user device further comprises predicting secondary content requests.

21. The non-transitory computer readable memory as defined in claim 15, the operations further comprising training at least one prediction model to make content request predictions utilizing one or more synthesized square waves corresponding to actual content requests.
